(19) United States
(12) Patent Application Publication
(10) Pub. No.: US 2017/0208983 A1
(43) Pub. Date: Jul. 27, 2017

(54) Energy Efficient Cooking Device

(71) Applicant: Eugene Roy Piercey, Lower Branch (CA)

(72) Inventor: Eugene Roy Piercey, Lower Branch (CA)

(21) Appl. No.: 15/415,458

(22) Filed: Jan. 25, 2017

(30) Foreign Application Priority Data
Jan. 25, 2016 (CA) 2919027

(51) Int. Cl. A47J 27/00; A47J 36/06

(52) U.S. Cl. CPC A47J 27/002; A47J 36/06

(57) ABSTRACT

An energy efficient cooking device comprising an outer wall for surrounding an enclosure above a heat source. At least one inner wall is disposed inside the enclosure. At least one flat bottom plate is connected to the at least one inner wall only or the outer wall and the at least one inner wall to form a cooking vessel. An area of the at least one bottom plate is smaller than an area surrounded by the outer wall for enabling air heated by the heat source to rise therethrough into a heated air space. The heated air rising up in the heated air space heats the inner wall, which heat is then transferred to the food contained in the cooking vessel.

This application claims priority to Canadian Patent Application No. 2,919,027, filed on Jan. 25, 2016, the entire contents of which are hereby incorporated by reference.

### FIELD

The present invention relates cookware, and more particularly, to an energy efficient cooking device that directs heat from a heat source between an inner wall and an outer wall thereof.

### BACKGROUND

Typically, present-day cookware such as pots and pans comprise a flat bottom plate and a wall extending from a circumference of the bottom plate forming a vessel for containing the food for cooking therein, with the bottom plate and the wall being made of a material having sufficient thermal conductivity such as, for example, stainless steel, aluminum and copper. For cooking the food, the cookware is placed onto a heat source such as, for example, the burner of a gas stove or the heating element of an electric stove, for providing heat to the bottom plate which is then transferred to the food resulting in a relatively slow and inefficient process.

Furthermore, many present-day households comprise only one or two people while meals typically comprise two or more food items that have to be cooked separately, resulting in the use of a plurality of burners/heating elements, each for cooking only a relatively small amount of food, thus further decreasing energy efficiency.

It is desirable to provide a cooking device that has increased energy efficiency by directing heat from a heat source between an inner wall and an outer wall thereof.

It is also desirable to provide a cooking device that has increased energy efficiency and that enables simultaneous separated cooking of a plurality of food items using a single burner/heating element.

It is also desirable to provide a cooking device that has increased energy efficiency and that is simple to use.

### SUMMARY

Accordingly, one object of the present invention is to provide a cooking device that has increased energy efficiency by directing heat from a heat source between an inner wall and an outer wall thereof.

Another object of the present invention is to provide a cooking device that has increased energy efficiency and that enables simultaneous separated cooking of a plurality of food items using a single burner/heating element.

Another object of the present invention is to provide a cooking device that has increased energy efficiency and that is simple to use.

According to one aspect of the present invention, there is provided an energy efficient cooking device. The cooking device comprises an outer wall for surrounding an enclosure above a heat source. At least one inner wall is disposed inside the enclosure. At least one flat bottom plate is connected to the at least one inner wall only or the outer wall and the at least one inner wall to form a cooking vessel. An area of the at least one bottom plate is smaller than an area surrounded by the outer wall for enabling air heated by the heat source to rise therethrough into a heated air space. The heated air rising up in the heated air space heats the inner wall, which heat is then transferred to the food contained in the cooking vessel.

According to an aspect of the present invention, there is provided an energy efficient cooking device. The cooking device comprises an outer wall for surrounding an enclosure above a heat source. The outer wall forms a ring structure for being placed onto the heat source. A plurality of cooking vessels are placed separately and removably inside the ring structure of the outer wall onto the heat source. The cooking vessels are designed for being placed such that there is heated air space between the walls of the cooking vessels and the outside wall, as well as between the walls of adjacent cooking vessels, enabling the heated air to rise up in the heated air space and heat the inner walls.

According to an aspect of the present invention, there is provided an energy efficient cooking device. The cooking device comprises an outer wall for surrounding an enclosure above a heat source. The outer wall forms a ring structure for being placed onto the heat source. A plurality of cooking vessels are placed separately and removably inside the ring structure of the outer wall. The cooking vessels are designed for being placed such that there is heated air space between the walls of the cooking vessels and the outside wall, as well as between the walls of adjacent cooking vessels, enabling the heated air to rise up in the heated air space and heat the inner walls. The outer wall comprises a flat bottom structure connected via connecting elements thereto to provide a ring shaped aperture between the bottom structure and the outer wall for enabling the heated air to rise up into the heated air space between the cooking vessels and the outer wall. The bottom structure is designed to be in direct heat transmitting contact with the bottom plates of the cooking vessels when placed thereon. The bottom structure further comprises apertures disposed therein and placed such that the heated air is enabled to rise up in the heated air space between adjacent cooking vessels.

One advantage of the present invention is that it provides a cooking device that has increased energy efficiency by directing heat from a heat source between an inner wall and an outer wall thereof.

A further advantage of the present invention is that it provides a cooking device that has increased energy efficiency and that enables simultaneous separated cooking of a plurality of food items using a single burner/heating element.

A further advantage of the present invention is that it provides a cooking device that has increased energy efficiency and that is simple to use.

### BRIEF DESCRIPTION OF THE DRAWINGS

An embodiment of the present invention is described below with reference to the accompanying drawings, in which:

FIGS. 1a and b are simplified block diagrams illustrating in a cross sectional view and a top view, respectively, an energy efficient cooking device according to an embodiment of the invention;

FIG. 1c is a simplified block diagram illustrating in a top view a lid of the energy efficient cooking device according to an embodiment of the invention;

FIGS. 1d and 1e are simplified block diagrams illustrating in top views variations of the energy efficient cooking device according to an embodiment of the invention;

FIGS. 2a and 2b are simplified block diagrams illustrating in a top view and a cross sectional view, respectively, an energy efficient cooking device according to another embodiment of the invention;

FIGS. 2c and 2d are simplified block diagrams illustrating in a side view and a cross sectional view, respectively, details of the energy efficient cooking device according to the other embodiment of the invention;

FIG. 2e is a simplified block diagram illustrating in a top view a variation of the energy efficient cooking device according to the other embodiment of the invention; and

FIGS. 2f and 2g are simplified block diagrams illustrating in a top view and a cross sectional view, respectively, another variation of the energy efficient cooking device according to the other embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to an energy efficient cooking device for use on a burner of a gas stove, it will become evident to those skilled in the art that the embodiments of the invention are not limited thereto, but that the energy efficient cooking device may also be employed using electric heating such as, for example, an electric stove, a glass-ceramic stove, or an induction stove.

It is noted that the term “cooking” will be understood hereinafter to include different cooking processes such as, for example, heating, boiling, frying, simmering, and sautéing.

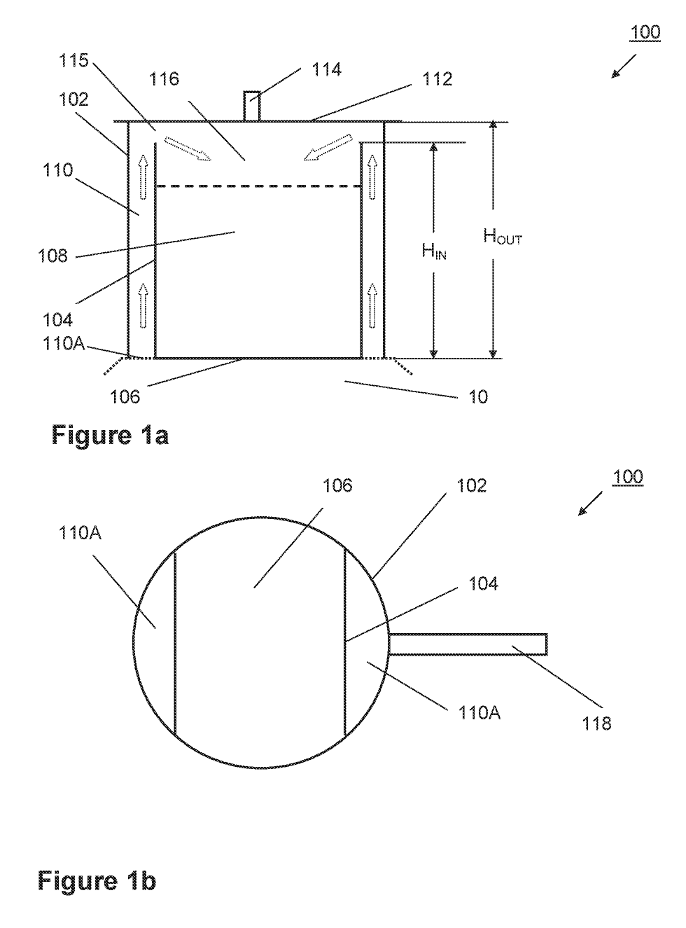

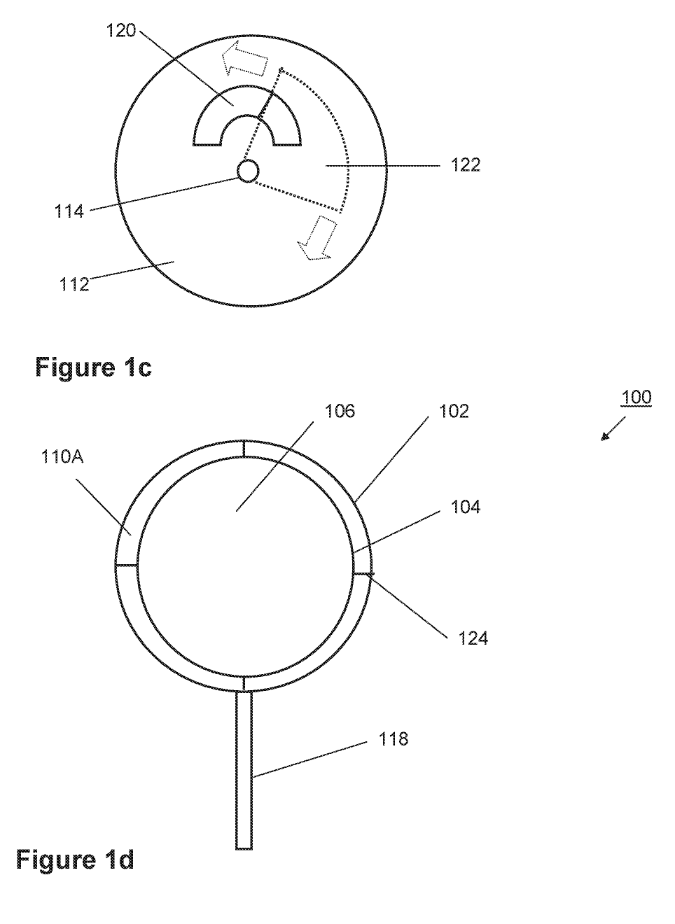

Referring to FIGS. 1a to 1e, an energy efficient cooking device 100 according to an embodiment of the invention is provided. The cooking device 100 comprises an outer wall 102 for surrounding an enclosure above a heat source 10 such as, for example, a burner of a gas stove. At least one inner wall 104 is disposed inside the enclosure. Flat bottom plate 106 is connected to the outer wall 102 and the at least one inner wall 104, as illustrated in FIG. 1b, to form cooking vessel 108 for containing the food therein, while providing apertures 110A for enabling air heated by the heat source 10 to rise therethrough into heated air space 110, as indicated by the block arrows in FIG. 1a. The heated air rising up in the heated air space 110 heats the inner wall 104, which heat is then transferred to the food contained in the cooking vessel 108.

The height R_{IN} of the inner wall 104 can be slightly less than the height H_{OUT} of the outer wall 102 leaving gap 115 of, for example, 10 mm, between the top of the inner wall 104 and lid 112 placed onto the outer wall 102 for covering the enclosure. The gap 115 enables the heated air to enter space 116 above the food—indicated by the dashed line in FIG. 1a—where it is contained for further heating the food. Optionally, the lid 112 comprises aperture 120 and cover plate 122 which is rotatable mounted to the lid 112 via knob 114, enabling control of the heat in the space 116 by turning the cover plate 122 via knob 114 to variably cover the aperture 120, as illustrated in FIG. 1c.

Provision of the aperture 110A for enabling rise of the heated air in the space 110 between the inner wall 104 and the outer wall 102 increases energy efficiency and speed by using the inner wall 104 and the space 116 above the food for transmitting heat to the food in addition to the bottom plate 106.

The cooking device 100 is made of, for example, conventional sheet material used for making cookware such as stainless steel, aluminum, copper, or various alloys using standard cookware manufacturing techniques such as bending, stamping and welding. Optionally, the inside surface of the cooking vessel 108 is coated, for example, with a PolyTetraFluoroEthylene (PTFE) based non-stick coating. Handle 118 is mounted to the outer wall 102 in a conventional manner. For example, the handle 118 is mounted to a handle stud using a screw fastener with the handle stud being welded or riveted to the outer wall 102. Alternatively, the handle 118 is directly welded/riveted to the outer wall 102. Optionally, two handles are mounted to opposite locations of the outer wall 102.

Alternatively, the bottom plate 106 is only connected to the inner wall 104, as illustrated in FIG. 1d, to form the cooking vessel 108, which is completely surrounded by heated air space 110. The inner wall 104 is connected to the outer wall 102 via connecting elements 124, thus allowing handling of the cooking device 100 in a conventional manner via handle 118 mounted to the outer wall 102. Optionally, the connecting elements 124 are adapted to removably connect the cooking vessel 108 to the outer wall 102 in a conventional manner—using, for example, pins and respective bores as mating connecting elements mounted to the inner wall 104 and the outer wall 102—in order to facilitate cleaning of the cooking device 100. Further alternatively, the outer wall 102 and the cooking vessel 108 each comprise a handle and are placed individually onto the heat source 10 with the outer wall 102 forming a ring structure surrounding the cooking vessel 108 when placed onto the heat source 10.

Further alternatively, a top portion of the cooking vessel 108 is shaped to form a spout 126 in contact with or protruding the outer wall 102 for facilitating pouring of the food contained therein, as indicated by the block arrow in FIG. 1e.

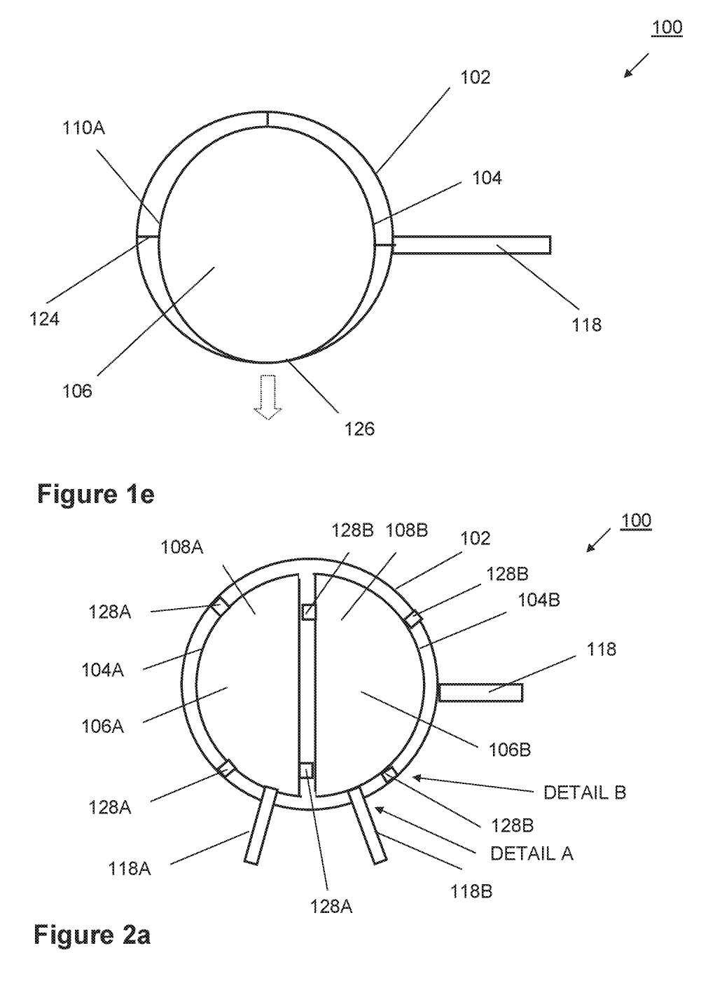

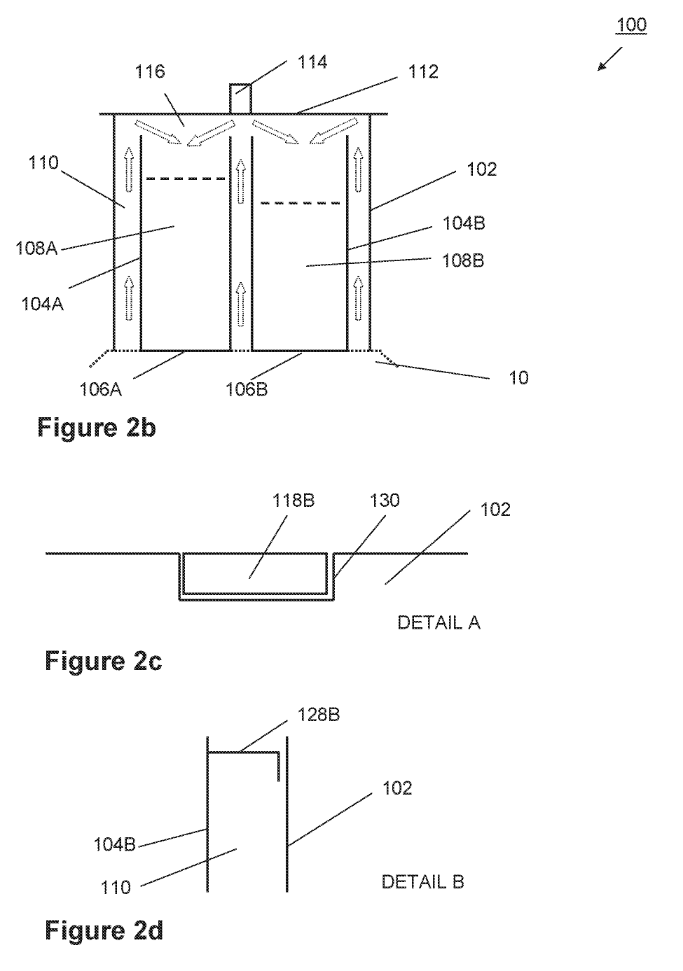

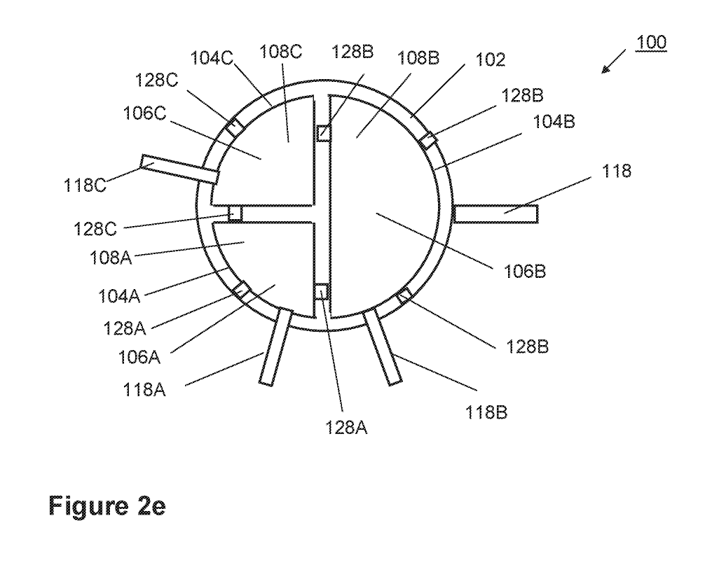

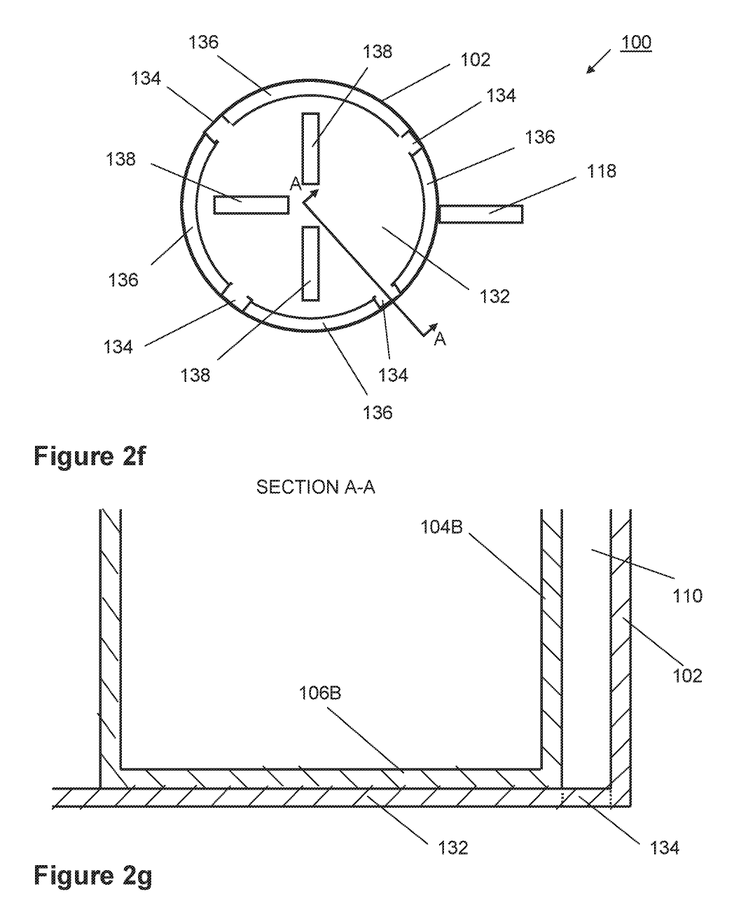

Referring to FIGS. 2a to 2g, an energy efficient cooking device 100 according to another embodiment of the invention is provided. Here, the outer wall 102 forms a ring structure for being placed onto the heat source 10. A plurality of cooking vessels 108—for example, two cooking vessels 108A, 108B or three cooking vessels 108A to 108C, as illustrated in FIGS. 2a and 2e, respectively—are placed separately and removably inside the ring structure of the outer wall 102 onto the heat source 10. The cooking vessels 108 can be designed for being placed such that there is heated air space 110 between the walls 104 of the cooking vessels 108 and the outside wall 102, as well as between the walls 104 of adjacent cooking vessels 108, enabling the heated air to rise up in the heated air space 110 and heat the inner walls 104, as illustrated in FIG. 2b.

Each cooking vessel 108A, 108B can comprise a respective handle 118A, 118B, as well as the outer wall 102 comprises handle 118. The outer wall 102 comprises recesses 130 for accommodating the respective handle 118A, 118B therein when the cooking vessels 108A, 108B are placed inside the outer wall 102, as illustrated in the detail of FIG. 2c.

Each cooking vessel 108A, 108B can comprise spacing elements 128A, 128B mounted thereto in order to ensure proper spacing—for example, 5 mm—between the walls 104 of the cooking vessels 108 and the outside wall 102, as well as between the walls 104 of adjacent cooking vessels 108, as illustrated in FIG. 2a. For example, the spacing elements are made of L-shaped strips of the same sheet material as the cooking vessels 108A, 108B and welded thereto, as illustrated in the detail of FIG. 2d.

The cooking vessels 108 and the locations of the recesses 130 can be provided such that different sized cooking vessels can be combined using the same outer wall 102. For example, the same cooking vessel 108B and outer wall 102 illustrated in FIG. 2a can be combined with the two smaller cooking vessels 108A, 108C illustrated in FIG. 2e. Optionally, the cooking vessels 108 are provided having different heights H_{IN} of the inner walls 104, for example, to combine a pot for boiling a food item with a pan for frying another food item using a same heat source 10. Here, the handles 118 of the cooking vessels 108 having the lower inner walls 104 are first angled upward for being accommodated in the same recesses 130 adapted to accommodate the handles of the cooking vessels 108 having the higher inner walls 104. Alternatively, the recesses 130 are extended downward to accommodate the handles of the cooking vessels 108 having the lower inner walls 104.

As is evident to those skilled in the art, there are numerous possibilities for combining various numbers of different sized cooking vessels having different heights and/or shapes. Furthermore, the outer wall 102 may be provided having different shapes than the circular shape as illustrated such as, for example, square shape, rectangular shape or oval shape.

Optionally, the outer wall 102 comprises a flat bottom structure 132 connected via connecting elements 134 thereto, as illustrated in FIGS. 2f and 2g, to provide a ring shaped aperture 136 between the bottom structure 132 and the outer wall 102 for enabling the heated air to rise up in the heated air space 110 between the cooking vessels 108 and the outer wall 102. The bottom structure 132 is designed to be in direct heat transmitting contact with the bottom plates 106 of the cooking vessels 108 when placed thereon. The bottom structure 132 further comprises apertures 138 disposed therein and placed such that the heated air is enabled to rise up in the heated air space 110 between adjacent cooking vessels 108.

The present invention has been described herein with regard to certain embodiments. However, it will be obvious to persons skilled in the art that a number of variations and modifications can be made without departing from the scope of the invention as described herein.

What is claimed is:

1. A cooking device comprising:
an outer wall for surrounding an enclosure above a heat source;
at least one inner wall disposed inside the enclosure;
at least one flat bottom plate, the at least one bottom plate being connected to one of:
the at least one inner wall; and
the outer wall and the at least one inner wall, to form a cooking vessel, wherein an area of the at least one bottom plate is smaller than an area surrounded by the outer wall.

2. The cooking device according to claim 1 comprising a lid placed onto the outer wall for covering the enclosure.

3. The cooking device according to claim 2 wherein the at least one inner wall and the lid are designed such that a gap is therebetween.

4. The cooking device according to claim 1 wherein the outer wall, the at least one inner wall and one bottom plate form the cooking vessel.

5. The cooking device according to claim 1 wherein one inner wall and one bottom plate form the cooking vessel, and wherein the cooking vessel is fixedly connected to the outer wall.

6. The cooking device according to claim 1 wherein the at least one inner wall and the at least one bottom plate form at least one cooking vessel and wherein the at least one cooking vessel is removable disposed inside the enclosure.

7. The cooking device according to claim 6 comprising a flat bottom structure connected to the outer wall, the bottom structure having an area smaller than the area surrounded by the outer wall, the bottom structure being designed to be in direct heat transmitting contact with the at least one bottom plate.
